(19) United States
(12) Patent Application Publication
(10) Pub. No.: US 2003/0097474 A1
(43) Pub. Date: May 22, 2003

(54) Method and system for the efficient communication of data with and between remote computing devices

(75) Inventors: Erin M. Defosse, Austin, TX (US); Mark Adler, Pasadena, CA (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Isochron Data Corporation

(21) Appl. No.: 10/330,366

(22) Filed: Dec. 27, 2002

Related U.S. Application Data
(63) Continuation-in-part of application No. 09/853,366, filed on May 11, 2001.
(60) Provisional application No. 60/203,682, filed on May 12, 2000.
(60) Provisional application No. 60/352,915, filed on Jan. 29, 2002.

(51) Int. Cl. G06F 15/16

(52) U.S. Cl. 709/246; 709/238

(57) ABSTRACT

A method and system for communicating between remote devices is provided. In one aspect, the method provides a compression engine available to a first device with previously communicated information. The compression engine then uses the previously communicated information and the information to be compressed to achieve improved compression ratios. After receiving the compressed information, the receiving device may provide the previously communicated information to a decompression engine, thereby enabling the received, compressed information to be effectively decompressed. With each communication of current device information, the previously communicated information may be updated with the current device information. As a failsafe for corrupt transmissions, out of date previously communicated information, etc., the receiving device may evaluate the integrity of the decompressed information and request a retransmission of the information using alternative compression techniques.

### CROSS REFERENCE TO RELATED APPLICATION

This application is a continuation-in-part application of U.S. patent application Ser. No. 09/853,366, filed by Erin M. Defosse et al. on May 11, 2001, entitled “METHOD AND SYSTEM FOR THE OPTIMAL FORMATTING, REDUCTION AND COMPRESSION OF DEX/UCS DATA,” and this application claims priority to U.S. Provisional Patent Application Serial No. 60/352,915 filed Jan. 29, 2002. The Ser. No. 09/853,366 application claims priority to U.S. Provisional Patent Application Serial No. 60/203,682 filed May 12, 2000.

### TECHNICAL FIELD

The present invention relates generally to data communications and, more particularly, to a compression method and system for communicating data between remotely located computing devices.

### BACKGROUND

Since the invention of the telephone, communications capabilities have been integrated into virtually every aspect of our business and personal lives. With this increased reliance on communications has come an increase in the infrastructure supporting communications. Despite this communications infrastructure increase, many of today's communications infrastructure users continue to experience bottlenecks and prohibitively expensive utilization fees.

While solutions to the problems of bottlenecks and usage fees have been attempted, e.g., fiber optic backbones, and DSL (Digital Subscriber Loop) and Cable Modems, communication link traffic issues remain. Some of the problems that have negated the recent advances in communications capabilities include the explosion of worldwide Internet and mobile phone usage as well as the growth of the global marketplace. Consequently, bottlenecks resulting from high traffic on communications infrastructure continue to exist and the market for airtime or bandwidth usage continues to belong to the sellers.

### SUMMARY

In accordance with teachings of the present disclosure, a method of communicating between a first device and a second device is provided. In one embodiment, the method preferably includes compiling information to be transmitted for the first device. The method preferably continues by accessing a memory included on the first device to determine whether a record of previously transmitted information is contained therein and, if located, providing the previously transmitted information as prior context for purposes of building a dictionary of encoded symbols for a compression engine capable of using dictionary data during the compression process. Subsequently, the method preferably compresses the information to be transmitted using the dictionary data and the compression engine capable of using dictionary data during the compression process. In the event that no previously transmitted information is available, the method preferably begins compressing the information using a standard compression engine without the use of dictionary data. Upon compression, the compressed information is preferably communicated from the first device to the second device.

In another aspect, the present invention provides a remote device management system including at least one remote device and a network operations center communicatively coupled to the at least one remote device. Preferably included on the remote device is a first program of instructions operable to determine whether a history of previously transmitted information is present in a memory of the remote device. If the history is present, the first program of instructions is preferably further operable to communicate the history to a compression engine capable of using dictionary data during a compression process such that current device information for the remote device may be compressed using a dictionary of encoded symbols computed from the history and the compression engine capable of using dictionary data during the compression process. If a history of previously transmitted information is not present, the first program of instructions is preferably further operable to begin compressing the current device information using standard compression technology without the use of dictionary data. Once the device information is compressed, the first program of instructions is preferably further operable to transmit the compressed device information to the network operations center via the communications interface, verify the accurate transmission and reception of the compressed device information and store the device information in the memory as previously transmitted information. A second program of instructions, included on the network operations center, is preferably operable to determine the method used by the remote device to compress the received compressed information. Upon such a determination, the second program of instructions is preferably further operable to decompress the compressed information according to the compression method used, verify that the compressed information was effectively decompressed and, if the decompression was ineffective, request retransmission of the device information. In addition, the second program of instructions is preferably further operable to store the decompressed information, determine if the decompressed information should form a part of a history of device information and, if so, store the device information as previously received device information to be used in subsequent compressed communication transactions with the device.

In a further aspect, the present invention provides a method for communicating information between a first source and a second source. In one embodiment, the method includes accessing information to be communicated from a memory of the first source, determining whether a model of the information to be communicated is available to the first source and, if the model is available, providing the model to a first compression engine. Continuing, the method preferably also includes generating, by the first compression engine, a character predicting probability distribution, providing the first compression engine with the information to be communicated and compressing, by the first compression engine, the information to be communicated according to the character predicting probability distribution. The method preferably further includes, if the model is not available, providing to a second compression engine the information to be communicated and compressing, by the second compression engine, the information to be communicated. Once the desired information has been compressed, the method preferably continues by transmitting the compressed information to the second source.

In one technical aspect, the present invention provides the advantage of reducing airtime charges on wireless networks by reducing the amount of information required to be transmitted while still achieving comprehensive and reliable data communications.

In another technical aspect, the present invention provides a compressed communications scheme capable of adapting to a multitude of input information formats as well as a variety of different computing environments.

In yet another technical aspect, the present invention provides the advantage of high compression ratios for generally static information inputs.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a functional block diagram of one embodiment of a distributed, remote device system, such as point of sale equipment, according to teachings of the present invention;

FIG. 2 is a functional block diagram of one embodiment of a network operations center according to teachings of the present invention;

FIG. 3 is a functional block diagram illustrating a system and method for efficiently communicating data with and between remote computing devices according to teachings of the present invention;

FIG. 4 is a flow chart illustrating one embodiment of a method for preparing information for communication between remote locations according to teachings of the present invention; and

FIG. 5 is a flow chart illustrating one embodiment of a method for evaluating information communicated from a remote location according to teachings of the present invention.

### DETAILED DESCRIPTION

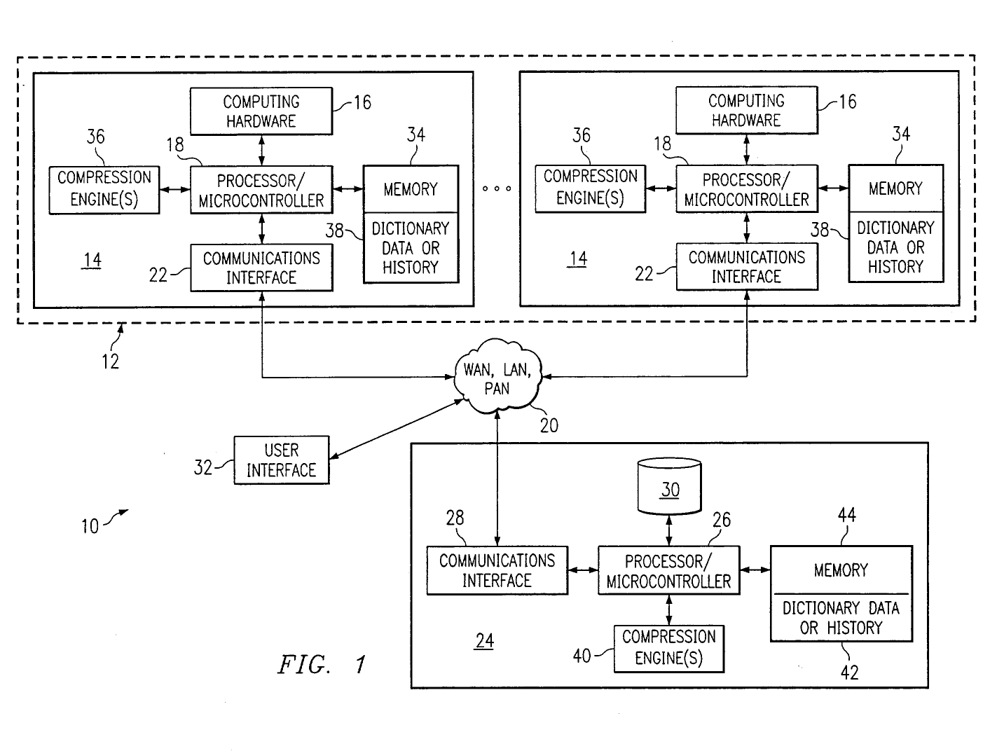

Preferred embodiments of the invention and its advantages are best understood by referring to FIGS. 1 through 5 of the drawings, like numerals being used for like and corresponding parts of the various drawings.

Various aspects of the present invention will be described with respect to remote computing devices. A remote data acquisition, transmission, and analysis system formed in accordance with teachings of the present invention may be used with and between a wide variety of machines such as computer work stations, personal digital assistants (PDAs), mobile phones, point of sale equipment, dispensing equipment, vending machines, photographic booths and any other types of equipment or machines with which communication may be desirable. The present invention is not limited to use with any particular computing device.

FIG. 1 is a functional block diagram of one embodiment of a data communication, acquisition, transmission, and analysis system, indicated generally at 10, incorporating teachings of the present invention. In general, system 10 of FIG. 1 preferably communicates information from a remote site 12 externally over a wide area wireless or wireline network 20. In one embodiment of system 10, remote computing devices 14 located at site 12 may also communicate internally over a local or personal area wireless or wireline network (not expressly shown).

The term “wireline transmissions,” as used herein, is used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wireline transmissions may be conducted in accordance with teachings of the present invention over electrical power lines, electrical power distribution systems, building electrical wiring, conventional telephone lines, T-1 lines, T-3 lines, ISDN lines, DSL, etc.

The term “wireless transmissions,” as used herein, is used to refer to all types of electromagnetic communications that do not require a wire, cable, or other types of conduits. Examples of wireless transmissions for use in local or personal area networks (LAN, PAN) include, but are not limited to Wi-Fi, Bluetooth, and IrDA, as well as other types of transmissions, especially in the 900 MHz and 2.4 GHz, and infra-red bands. Examples of wireless transmissions for use in wide area networks (WAN) include, but are not limited to, two-way paging, circuit switched cellular, cellular digital packet data (CDPD), GSM/GPRS, CDMA, etc.

For some applications, BLUETOOTH wireless technology may be satisfactorily used with system 10, particularly to establish a PAN or LAN and communication between the remote computing devices and handheld computing equipment. BLUETOOTH technology uses radio wave transmissions, which do not require line-of-sight and allow data communication through walls and other structures at relatively fast data transfer rates. A wide variety of handheld wireless devices and equipment has been or will be modified to include BLUETOOTH technology, including cell phones, personal data assistants (PDA), laptop computers, notebook computers, and similar devices. BLUETOOTH transmitters/receivers have been incorporated into both handheld devices and large stationary machines. BLUETOOTH uses the frequency range of approximately 2.4 GHz, which currently does not require a license. An alternative wireless technology that may be used in a wireless LAN or other implementation is the IEEE 802.11b, or Wi-Fi, standard.

Remote site 12 may include one or more remote computing devices 14. In one embodiment, the remote computing devices 14 included at remote site 12 may include remote POS (Point of Sale) devices. POS devices may include vending hardware and inventory for performing vending or other operations as well as for electronically tracking some assorted functional, operational or other information.

According to teachings of the present invention, remote devices 14 may include a processor or microcontroller 18 coupled to and interfacing with computing hardware 16. Computing hardware 16 may include such hardware as storage devices, data recording equipment, sensing equipment as well as others.

Some varieties of remote computing devices 14 may be equipped with electronics for controlling various operations as well as tracking various events. Processor 18 is preferably operable to communicate with any embedded electronics of remote computing device 14 as well as equipped to directly sense other events and equipment or hardware parameters.

Processor 18 preferably acquires data captured by computing hardware 16 and is preferably operable to package and communicate that data across network 20 using communications interface 22. Various components discussed herein may be installed together inside remote computing device 14 or housed separately in another location. Specifically, a processor present in the computing hardware could be used to implement all of the compression, communications, and data storage functions.

Communications interface 22 may be implemented using one or more of a number of technologies. In particular, communications interface 22 is designed to support a wide area network 20 that can be implemented via wireline or wireless transmissions. If a wireless narrowband PCS paging network is used to implement WAN 20, messages from a remote computing device 14 may be communicated as digital messages through the paging network and stored in one or more message mailboxes or transmitted directly by the carrier through some other electronic means such as e-mail, FTP, direct socket connection, etc. Any of the means described above may be implemented securely and reliably, for example, through an Internet-based connection.

In general, processor or microcontroller 18 of remote computing device 14 interfaces to the internal systems of remote computing device 14 preferably to perform data acquisition and control functions and to provide a wireline and/or wireless data communication transceiver for establishing a communication link with communications interface 22. Computing hardware 16 may include electro-mechanical components, some or all of which may be preferably coupled to and interfaced with a hardware controller (not expressly shown).

Processor or microcontroller 18 preferably interfaces with computing hardware 16. This interface may include a serial interface (not expressly shown), e.g., Universal Serial Bus (USB), RS-232, RS-485, MDB, or any other data interface standard that communicates with the processor (18) using a standard data protocol, e.g., DEX/UCS (Direct Exchange/Uniform Communications Standard), VCCS, or Multi-Drop Bus (MDB) in a vending machine environment or MODBUS, Fieldbus, or CAN in other types of industrial devices. The interface may also include the ability to directly sense the various components included in computing hardware 16 using digital and analog sensors (not expressly shown). In such an embodiment, analog sensors may be coupled to analog-to-digital (A/D) converters (not expressly shown) to convert analog measurements to digital signals.

Processor or microcontroller 18 can communicate event and other data using a wireline or wireless communications interface 22 that sends the data via wireline or wireless transmissions respectively. Processor 18, in one embodiment, can transmit/receive data to/from a local communications hub (not expressly shown) located at the remote site or to/from a hand-held portable computing device either directly or via the hub.

Further, remote computing devices 14 may include various types of memory units 34 such as random access and read-only memory (RAM/ROM), FLASH memory and/or Electrically Erasable/Programmable read-only-memory (Flash memory/EEPROM) for storing application code and equipment data. The Flash memory can be remotely programmed via communications interface 22 in the event that its data becomes corrupted or requires upgrade. The present invention is not limited to any specific type of memory unit. Further, remote computing devices 14 may include a power supply and a backup battery.

In general, processor 18 can communicate externally either directly or through a local hub to establish a link with another remote computing device 14, such as another remote computing device, other device or equipment, or network operations center (NOC) 24, thus enabling the formation of a WAN. In such an embodiment, the local hub may include a microprocessor that communicates with one or more processors 18 using a LAN transceiver. This communication, for example, can involve wireline and/or wireless transmissions depending upon the operating characteristics of the LAN transceiver. The local hub may also include a processor to effectively form a remote computing device 14 itself when collocated with computing hardware 16.

Processor 18 can receive data captured from computing hardware 16, process the data and store the data in a mass storage device (not expressly shown) such as a hard drive, solid-state recorder, or FLASH memory. Processor 18 can then retrieve data and communicate data externally using a wireline or wireless communications interface 22 communicating via wireless or wireline transmissions, respectively. Memory 34 may also be used for storing application code, such as a compression engine or engines 36, as well as other data or information, such as previously transmitted information (history) 38. Previously transmitted information 38 may contain, for instance, device status information previously communicated between remote computing device 14 and NOC 24, dictionary data derived from previously communicated device status information, or both. Previously transmitted information 38 may also be referred to in general as history 38.

As shown in FIG. 1, system 10 preferably includes a NOC 24 operable to communicate with one or more remote sites 12 via wide area network 20. In one implementation, NOC 24 can access messages transmitted by processors 18 at remote sites 12. In the embodiment illustrated in FIG. 1, NOC 24 may include one or more processors or microcontrollers 26 operable to communicate with wide area network 20 through communications interface 28. NOC 24 is preferably operable to receive data acquired from and transmit data to remote sites 12, process the data and store the data or information in storage 30. Portions of the communications between NOC 24 and remote sites 12 are preferably implemented using compression engines 40 and history or dictionary data 42 stored in memory 44. A method for communicating with and between remote sites and devices according to teachings of the present inventions is discussed in greater detail below.

NOC 24 may also be configured to perform instant alert paging, direct dial alarms and other functions to provide real time notification to a remote computing device 14 or equipment operator upon the occurrence of certain events. NOC 24 may also be operable to provide third-party transaction processing such as allowing queries on storage 30. WAN interface 28, communicatively coupling NOC 24 to wide area network 20, may be implemented through the use of either wireline and/or wireless technologies.

NOC 24, in one embodiment, may be accessed from a client system 32 across WAN 20. In one implementation, client system 32 may communicate with NOC 24 using a web-based interface allowing user access from a client computer across a network such as the Internet. Other implementations include providing a direct-dial or leased line connection between client system 32 and NOC 24.

Once connected, a user may use client system 32 to obtain information from storage 30 based upon data acquired from remote sites 12. Further, users may be provided with extended services such as trend information developed by mining and analyzing databases available in storage 30.

A wide variety of software applications and programs may be satisfactorily used with processors 18, NOC 24, and client system 32. For example, various components of system 10 may include operating systems such as UNIX, Macintosh OS, and Windows. The software program applications associated with system 10 may use Java, C/C++ or any other suitable program language or application environment.

System 10 may also be operable to use different types of markup languages for communicating with NOC 24. Such markup languages may include, but are not limited to, Hypertext Markup Language (HTML), Extensible Markup Language (XML), and Wireless Markup Language(WML).

Various communication protocols and applications may be used by one or more components of system 10 to communicate information and data associated with operation, maintenance, and control of remotely located computing devices 14. Such communication protocols and applications include, but are not limited to, Internet Protocol (IP), Transmission Control Protocol (TCP), Transmission Control Protocol/Internet Protocol (TCP/IP), Wireless Application Protocol (WAP),Global System for Mobile (GSM)communications, Time Division Multiple Access (TDMA), Code Division Multiple Access (CDMA), User Datagram Protocol (UDP), Wireless Session Protocol (WSP), Wireless Transaction Protocol (WTP), Wireless Datagram Protocol (WDP), iMode, SOAP, PQA (Palm Web Clippings) and the various sync protocols used by Windows CE, PocketPC, Palm OS, or Symbian-based computers.

Examples of computing devices which may be satisfactorily used, e.g., via client system 32 or otherwise, with a data acquisition, transmission, and analysis system 10 in accordance with teachings of the present invention include, but are not limited to, mobile phones, internet phones, one-way pagers, two-way pagers, personal data assistants (PDAs), handheld computers, laptop computers, and portable computers capable of wireless or wireline communications. Computing devices satisfactory for use with the present invention may include only one-way communication of data to or from the associated NOC or may allow two-way communication between the computing devices as well as between the computing devices and the associated NOC.

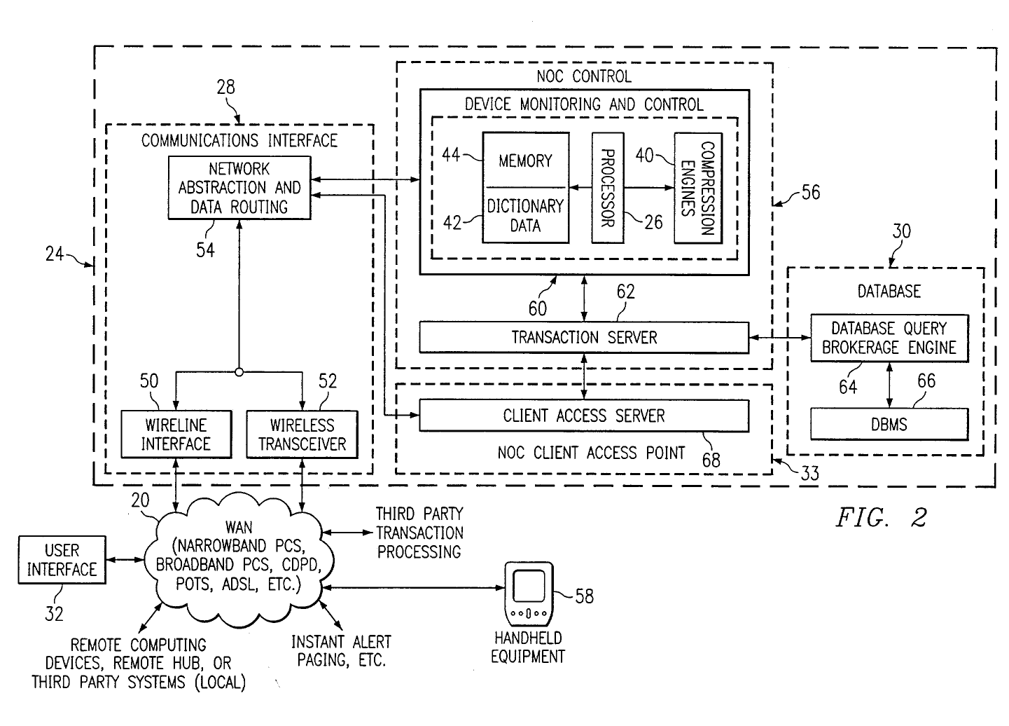

FIG. 2 is a functional block diagram of a NOC 24 incorporating teachings of the present invention. As shown, communications interface 28 can include various interface devices such as a WAN wireline interface 50 or wireless transceiver 52 communicating via wireline or wireless transmissions respectively. These interface devices may support connections to external network 20 and may communicate internally with a network abstraction and data routing unit 54.

Unit 54 can route data to NOC control 56 or a client access point as appropriate. Unit 54 may also be used to provide one or more software applications for use by handheld equipment 58, remotely located computing devices 14, local hubs and/or processors 18 at remote site 12.

The software applications provided by NOC control 56 through unit 54 and WAN 20 may be used for various purposes such as establishing a local database within a local hub (not expressly shown), processors 18 and/or handheld equipment 58. The applications provided by NOC control 56 and unit 54 may also be used to allow handheld equipment 58 to perform various operations on remote computing devices 14. For example, an application or data may be downloaded from NOC 24 to handheld equipment 58 for use in operating a respective remote computing device 14, changing operations characteristics (increasing or decreasing the price of a product in a vending machine environment) or performing other functions such as downloading operational data from the device. The present invention may also allow NOC 24 to function as an application service provider. Therefore, a wide variety of software applications may be downloaded from NOC control 56 to handheld equipment 58 and/or an associated remotely located device, such as remote computing device 14, to allow performance of a wide variety of functions including operating, maintaining and servicing remote equipment.

NOC control 56 may include one or more device monitoring and control units 60 and transaction servers 62 that have access to database 30. Database 30 can include a database query brokerage engine 64 connected to a DBMS 66. Client access point 33 can include a client access server 68 that also has access to database 30 through transaction server 62 or via other means. Transaction servers 62 may also operate to receive data acquired from remote computing devices 14, store and maintain data in database 30, and provide access to database 30. Client access point 33 may also operate to support client access to NOC 24 and database 30.

Monitoring and control unit 60 may include, among other components, processor 26, compression engines 40 and history or dictionary data 42 stored in memory 44. In an effort to reduce communications time and hardware usage, NOC 24 preferably communicates with remote site 12 using compression engines 40 and, depending on the compression engine 40 used, history or dictionary data 42. As will be discussed in greater detail below, preferably all communications between NOC 24 and remote site 12 are compressed/decompressed using one or more compression engines 40 at NOC 24 and one or more similar compression engines 36 on a remote computing device 14 at remote site 12. History 42 at NOC 24 and history 38 on remote computing devices 14 are also preferably used with at least one of the compression engines 40 capable of using dictionary data as part of the compression process available at NOC 24 and remote computing device 14, respectively.

In general, the present invention describes a more effective and efficient method and system for communicating with and between remote computing devices. In one aspect, a new remote computing device, such as industrial equipment, a remote computer, or any other device is launched into the field or into service. At a scheduled reporting time or in response to a request from the NOC 24, a newly launched remote computing device 14 compiles its current status telemetry data or other requested data, collectively referred to as telemetry data. Telemetry or other requested data may include, but is not limited to, vends made and monies received in a vending machine environment, updated or altered files in a remote computer environment, and production output in an industrial equipment environment. Teachings of the present invention may be employed with virtually any computer readable data or information format.

Once the current telemetry data for the remote computing device 14 has been compiled, the current telemetry data is preferably compressed using a standard compression engine such as ZLIB, ZIP, PkZip, WinZip, etc. Upon compression of the initial, current operational data, the remote device preferably communicates the compressed information to the NOC 24 via a wireless or wireline communications link, such as WAN 20 or indirectly through a handheld or portable computer equipment 58. In addition, the remote device 14 preferably stores some or all of the initial, current operational data, when appropriate, as detailed below, in a memory unit preferably included thereon. The copy is preferably stored in what may be referred to as a history or dictionary data 38 of remote device data.

Upon receipt of the compressed initial, current operational data by the NOC 24, the information is preferably decompressed using a decompression engine compatible with the compression engine used by the remote device 14. In one embodiment, the NOC 24 may be configured to determine the compression method used. In alternate embodiments, a predetermined compression engine may have been established, or the NOC 24 and the reporting remote device 14 may have negotiated the compression method to be used.

Once the initial, current operational data has been decompressed, the NOC 24 may perform one or more diagnostics on the data or may store the data for later evaluation. Diagnostics that may be performed by the NOC 24 include, but are not limited to, determining whether the remote device 14 is in need of maintenance, inventory, etc., or whether certain events have occurred as indicated by the initial, current operational data. Similar to the remote device 14, some or all of the decompressed initial, current operational data is also preferably stored by the NOC 24 as a history or dictionary data 42. The NOC then preferably returns to a wait state to await another operational data transmission from a remote device 14.

At the next reporting time, or upon command from the NOC 24, the remote device 14 compiles its now current operational data. Also at the next reporting time, whether in response to a request received from the NOC 24 or due to the arrival of the remote device's 14 next scheduled reporting time, the remote device 14 preferably checks for the presence of a history or dictionary data 38 resulting from the remote device's 14 previous reporting. If a history or dictionary data 38 is available to the remote device 14, the remote device 14 preferably provides the history or dictionary data 38 to a compression engine 36 capable of using dictionary data as part of the compression process. An example of a compression engine 36 capable of using externally supplied dictionary data (e.g., a dictionary of encoded symbols or prior context) during the compression process is ZLIB. As described in greater detail below, the compression engine 36 may interpret and use the history or dictionary data 38 to compress the current operational data for the remote device 14. Upon completion of compression, the compressed current operational data is transmitted to the NOC 24, again via a wireless or wireline communication link or intermediate device, and some or all of the current operational data may be stored by the remote device 14 as a new history or dictionary data 38 or added to an ongoing history database or dictionary database 38 maintained by the remote device 14.

Upon receipt of the reporting from the remote device 14, the NOC 24 preferably decompresses the data. To effectively decompress the data, the NOC 24 may first select the appropriate compression/decompression engine. As mentioned above, the NOC 24 may review the compressed information to make a determination as to the compression method used by the remote device 14. Alternatively, the NOC 24 may have requested that the data from the remote device 14 be compressed using an identified compression engine, the remote device 14 and the NOC 24 may have negotiated the compression engine to be used, or the NOC 24 may maintain a setting for the various compression methods used by the remote device 14.

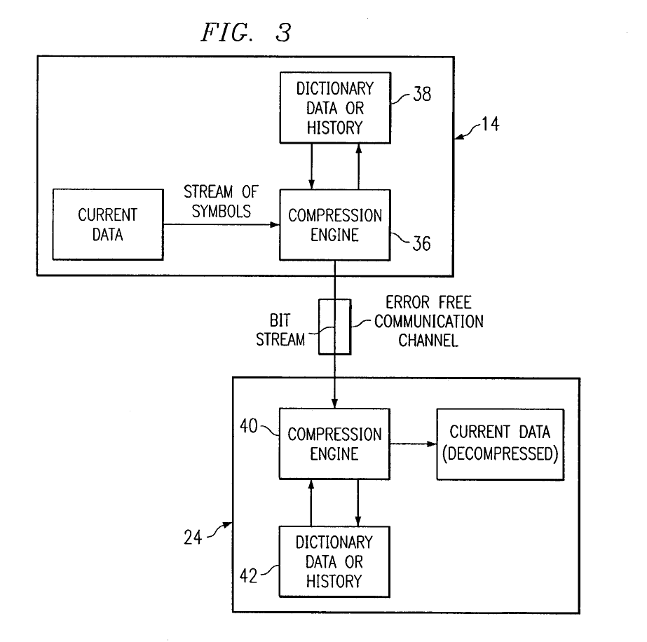

FIG. 3 is a functional block diagram illustrating an example embodiment of a system and method for efficiently communicating data with and between remote computing devices according to teachings of the present invention. In this block diagram compression engine 36 uses the dictionary data 38 as prior context, used together with a model to optimally encode the various symbols encountered according to the probability distribution of the various symbols and according to the probability of the current symbol in the context of the string of symbols that precede it. In particular, strings of symbols that occur in the data that are also present in the dictionary can be represented very compactly by the compression engine 36. For cases where the history and resulting dictionary data are similar to the current data to be compressed, the encoded symbols identified by inspecting the dictionary data are highly effective for the purpose of compressing the current data. In one extreme case, if the history is identical to the current data, the entire current data could be encoded with a very small number of encoded symbols.

The data dictionary or history 38 may contain a predetermined portion of the previous symbols processed by compression engine 36. For instance, the history 38 used by compression engine 36 may be the previous “n” bytes processed, where “n” equals 32,768, for example. History 38 may thus be used as a sliding “n”-byte window over the data, ending just before the current byte being processed, with the contents of the history 38 constantly changing through the compression process.

As described in greater detail below, in one embodiment, compression may start without history 38 or with history 38 empty or only partially full in certain circumstances, such as for an initial data transfer. When compression starts without history 38, since there is nothing before the first byte, the first byte will not match anything and will therefore always sent as a literal. Additionally, for the first “n” bytes, there will be fewer than “n” bytes in the sliding window to search for string matches. This results in a smaller chance of finding a match, and results in shorter matches when it does find them. Compression may therefore be sub-optimal through the first “n” bytes of input. The above considerations typically apply as well to compression engine 40 and history 42. In the example embodiment, however, by retaining a copy of the history 38 in the remote device 14 and a matching copy in the NOC 24 and using those histories to seed the process for compressing and decompressing subsequent data transmissions, the disclosed system improves compression effectiveness.

In an alternative embodiment, a predetermined history may be used for all transmissions, thereby avoiding the occasional condition of an empty, corrupt, or invalid history. The predetermined history may be referred to as a static history, a static data dictionary, or a static seed. The static seed my be populated with data that has been determined to be representative of the data to be communicated, for example based on analysis of actual data samples. Different static seeds may be used for different categories of remote devices.

Accordingly, for purposes of this document, the term “prior device status information” may be used to refer to static information (e.g., a predetermined history, as described above) or to dynamic information (e.g., actual status data that has been collected from a remote device and transmitted to a NOC).

In the example embodiment, once history or dictionary data 38 on the remote device 14 and history or dictionary data 42 on the NOC 24 have been stored, for subsequent communications to NOC 24, remote device 14 may use dictionary data 38 and a compression engine 36 capable of using dictionary data during the compression process, and NOC 24 may utilize the appropriate decompression engine 40 and dictionary data 42 to decompresses the data. Alternatively, the history 38 on the remote device 14 and the history 42 on the NOC 24 may be stored and then converted into dictionary data when compression and decompression take place.

Upon decompression, the NOC 24 may perform one or more diagnostics as mentioned above. In addition, when appropriate, as detailed below, the NOC 24 will preferable store some or all of the decompressed data as a history or dictionary data 42 for the remote device 14. Alternatively, the NOC 24 will update a history database or dictionary database 42 for the reporting remote device 14.

According to teachings of the present invention, various sorts of data may be used. While the description herein discusses telemetry data, other formats, types and forms of data are considered within the scope of the present invention.

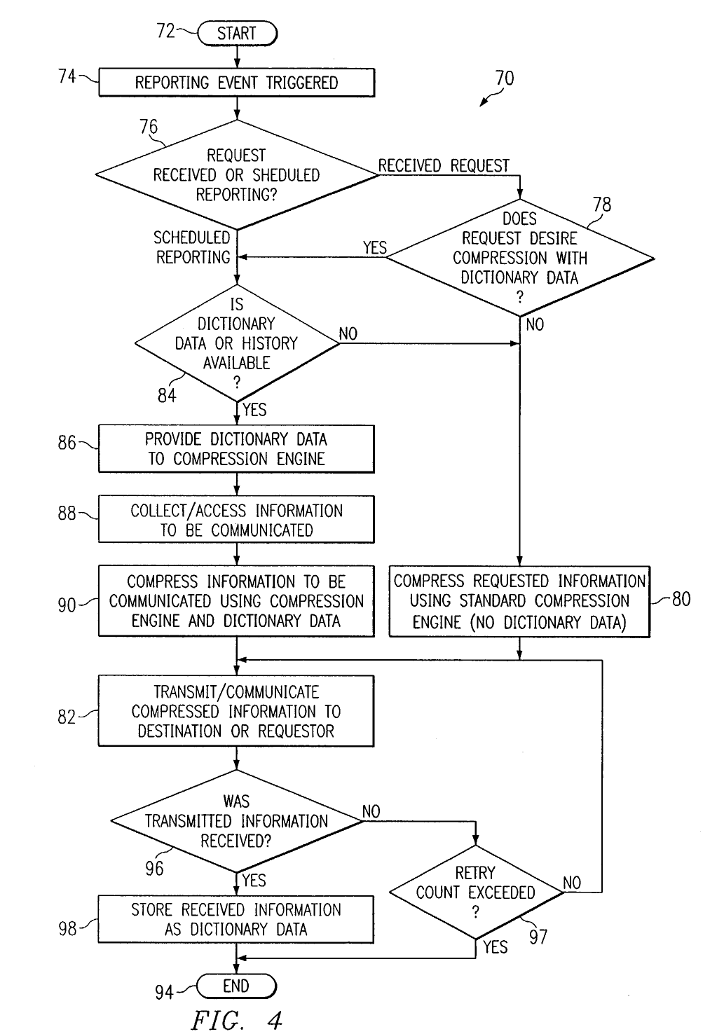

FIG. 4 illustrates one embodiment of a method for communicating data from a remote computing device 14 to a NOC 24 incorporating teachings of the present invention. Method 70, preferably implemented on one or more remote computing devices 14, of FIG. 4 begins at 72 and proceeds to 74 where acknowledgement of a reporting event is triggered. According to teachings of the present invention, a reporting event may be defined as the arrival of a scheduled reporting time for a particular remote computing device 14 or as receipt by a first source, such as remote computing device 14, of a request for telemetry data from a second source, such as NOC 24. Other reporting event triggering mechanisms are considered within the scope of the present invention.

Once a reporting event has been triggered and acknowledged at 74, method 70 preferably proceeds to 76 where a determination is made as to the type of reporting event triggered. In one embodiment of the present invention, a reporting event may be triggered by the arrival of a scheduled reporting time or a reporting request receipt.

If at 76 the reporting event was triggered in response to the receipt of a reporting request, method 70 preferably proceeds to 78. At 78, the reporting request is preferably evaluated to determine whether the requesting source indicates a desire for the compression of the requested data using dictionary data 38.

If the request does not indicate a desire for the use of dictionary data, method 70 preferably proceeds to 80. At 80, the information requested by the NOC 24 (e.g., transactional information, operational information, file updates, etc.) is preferably compressed without the use of dictionary data using one or more standard compression engines available from compression engines 36. Standard compression engines capable of compression without the use of dictionary data include, but are not limited to, ZLIB, PkZip, ZIP, WinZip, GZIP, etc. Alternatively, compression may begin without dictionary data, with dictionary data accumulated during compression. Concurrent with, prior to, or otherwise in association with 80, the information requested by the NOC 24 may be compiled by the current remote device 14. Consequently, such a modification may be made to method 70 without departing from its spirit and scope. Once the requested information has been compressed, method 70 preferably proceeds to 82.

If at 76 the reporting event is determined to be triggered by the arrival of a scheduled reporting time, or if it is determined at 78 that the reporting request desires compression with dictionary data, method 70 preferably proceeds to 84.

At 84, the remote device 14 reviews the contents of its memory 34 or storage devices to determine whether a history or dictionary data 38 for the remote device 14 is available. If the remote device 14 is unable to locate a history or dictionary data or, alternatively, determines that a history or dictionary data has not been previously stored, method 70 preferably proceeds to 80 where, as mentioned above, the requested information is compressed using a standard compression engine without the use of dictionary data. Alternatively, as mentioned above, compression may begin without dictionary data, with dictionary data accumulated during compression. If at 84, the remote device 14 locates an available history or dictionary data 38, method 70 preferably proceeds to 86.

At 86, the reporting remote device 14 preferably provides the history or dictionary data 38 to a compression engine available from compression engines 36 capable of using dictionary data during the compression process in order to encode symbols encountered during the compression of the current data. By providing such a dictionary of encoded symbols to the compression engine 36, the remote device 14 will be able to achieve higher compression ratios if the current data is similar to the history. From 86, method 70 preferably proceeds to 88 where the reporting remote device 14 collects or accesses the information to be communicated to the NOC 24. The information collected may include one or more operational characteristics of the remote device 14, data collected by the remote device 14, transactional activities of the remote device 14, file updates, production outputs, as well as many other types of information.

Once the information to be communicated has been collected or accessed at 88, method 70 preferably proceeds to 90 where the information is compressed using the primed compression engine capable of using dictionary data during the compression process. Preferably, the dictionary data 38 provided to the compression engine at 86 is generally representative of or similar to the information collected or accessed at 88. Using a representative history 38 may enable the compression engine to achieve greater compression ratios and thereby maximize communication link utilization efficiency.

Upon compression at 90, method 70 preferably proceeds to 82 where the compressed information is transmitted or communicated to its appropriate destination or requester, such as NOC 24. Once the compressed information has been transmitted at 82, method 70 preferably proceeds to 96.

At 96, method 70 preferably performs one or more analyses on the compressed information transmission to determine whether the compressed information was received. Upon a determination at 96 that the compressed information was not properly received, method 70 may proceed to 94 where the method ends. Alternatively, as provided by block 97, method 70 may reattempt transmission of the data at 82 a predetermined number of times before proceeding to 94 where the method ends. If at 96 it is determined that the compressed information was properly received, method 70 preferably proceeds to 98.

At 98, method 70 preferably stores the current information as an updated history or dictionary 38 for the remote device 14 or adds the current information to a history database or dictionary database 38 for the remote device 14. Once the current information is stored, method 70 preferably ends at 94.

In an alternative embodiment, before the remote device 14 stores the transmitted data, the remote device may determine whether the transmitted data was the remote device's 14 current information. In one embodiment, the remote device 14 may only maintain a history 38 indicating the remote device's 14 most recent state. However, alternative embodiments of the present invention may maintain a history or dictionary data for more than one aspect of a remote device's 14 operation or functionality. If the information transmitted was not indicative of the current state of remote device 14, the method may bypass block 98 and end without updating history or dictionary data 38. On the other hand, if the transmitted information is determined to be the current information for the reporting remote device 14 (i.e., current information for one or more histories maintained by remote device 14), the method preferably stores the current information as a new or updated history or dictionary database 38 for the remote device 14, or adds the current information to a history or database 38.

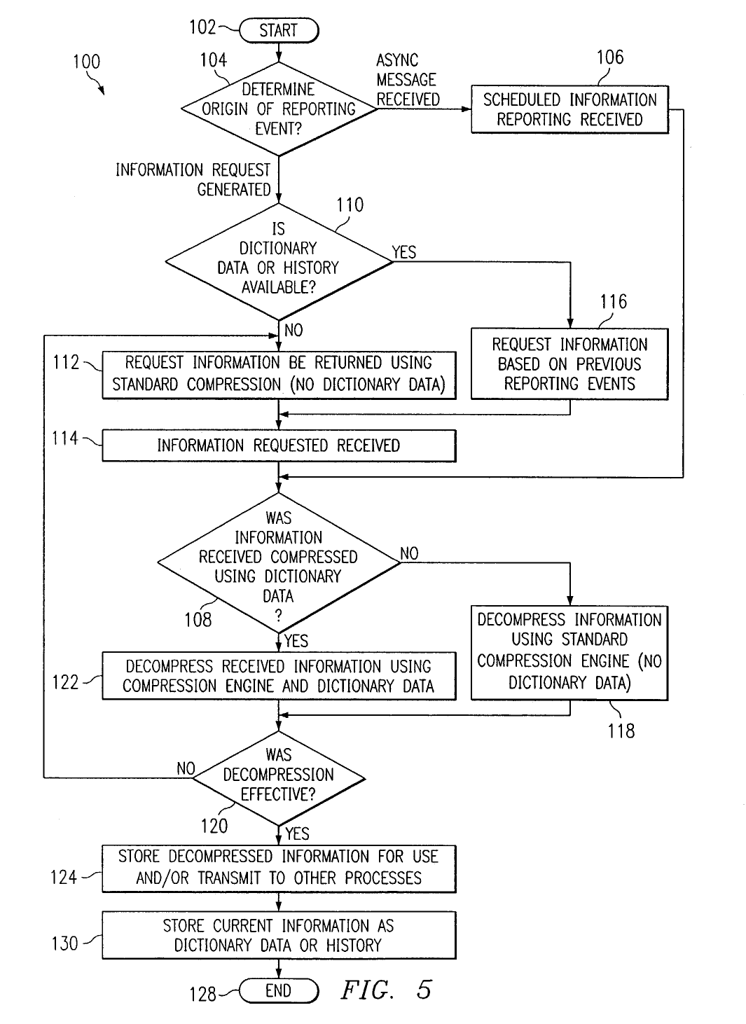

FIG. 5 illustrates one embodiment of a method, preferably operational at a NOC 24 or other device communicatively coupled to a remote device 14, for communicating with one or more remotely located devices according to teachings of the present invention. Method 100 preferably functions in conjunction with method 70 to minimize communications link, such as network 20, demands while providing complete and accurate data transfer between one or more remotely located devices 14 and a NOC 24.

Method 100 preferably begins at 102. Method 100 may be initiated at 102 by any of a plurality of methods. For example, method 100 may be initiated or started in response to receipt of a communication or reporting event, such as in the form of an asynchronous communication event initiated from a remotely located device 14. Alternatively, method 100 may be initiated or started in response to a request for communication sent to a remotely located device 14 from the NOC 24 implementing method 100. Alternative methods of initiating method 100 are considered within the scope of the present invention's teachings.

Upon starting at 102, method 100 preferably proceeds to 104 where a determination regarding the origin of the current reporting event is made. As mentioned above, one possible origin of a reporting event may result from an asynchronous message received from a remote device 14 attempting to report its status information. Alternatively, management functionalities included in the NOC 24 may have generated a request for information from a remote device 14 to which the current reporting event is a response.

If the current reporting event is the result of scheduled reporting by the remote device 14, e.g., an asynchronous message received by the NOC 24 from a remote device 14, method 100 preferably proceeds to 106 where the remote device's 14 information may be received by the NOC 24. Upon receipt of the remote device's 14 information, method 100 preferably proceeds to 108.

If the current reporting event received at 104 is determined to be a response to a request for information generated by the NOC 24 and communicated to a remote device 14, method 100 preferably proceeds to 110. At 110, the NOC 24 preferably searches one or more of its memory devices 44 or storage devices 30 to determine whether a history or dictionary data 42 for the reporting remote device 14 is available.

Where a history or dictionary data 42 for the reporting remote device 14 is unavailable or not located, method 100 preferably proceeds to 112. At 112, the NOC 24 preferably generates and communicates a request for the reporting remote device 14 to communicate the requested information using a standard compression engine and without using a history or dictionary data to seed the compression process, as mentioned above. At 114, the information requested by the NOC 24 may be received and its integrity validated.

Where a history or dictionary data 42 is located by the NOC 24, an information request is generated and communicated from the NOC 24 to the reporting remote device 14 at 116. The information request generated and communicated at 116 preferably indicates that the remote device 14 is to communicate requested information in a compressed format where the compressed format utilizes a compression engine capable of using dictionary data during the compression process. Similar to the performance after 112, method 100 preferably proceeds from 116 to 114 where the requested information in the requested format is received by the NOC 24. From 114, method 100 preferably proceeds to 108.

At 108, method 100 preferably evaluates the received information to make a determination as to the methodology with which the information was compressed. Such a determination may be required due to the possibility, as mentioned above, that the remote device 14 is unable to locate a history or dictionary data 38 with which it can compress requested information using a compression engine capable of using dictionary data during the compression process.

Evaluation of the received information may be made according to a number of methodologies. For example, the format, header information, or file extension of the received compressed information may be reviewed. Alternative methods of determining the means with which the received information was compressed are considered within the scope of the present invention.

If at 108 it is determined that the received requested information was compressed using standard compression technology not seeded with history data, method 100 preferably proceeds to 118. At 118, the received information may be decompressed using an appropriate or related standard decompression engine. After decompression at 118, method 100 preferably proceeds to 120.

If at 108 it is determined that the received requested information was compressed using a compression engine capable of using dictionary data during the compression process and a history or dictionary data for the reporting remote device 14, method 100 preferably proceeds to 122. At 122, the NOC 24 may decompress the received information using a history or dictionary data 42 for the reporting remote device 14 located at the NOC 24 and a corresponding compression engine capable of using dictionary data during the compression process. Upon completion of decompression at 122, method 100 preferably proceeds to 120.

At 120, method 100 preferably evaluates the integrity or effectiveness of the decompression. For example, method 100 might evaluate a short check value computed on the uncompressed data compared to a check value computed on the original data and communicated to the NOC 24 as part of the transmission. Examples of short check values that might be used include, but are not limited to CRC (Cyclic Redundancy Check) values, Adler32 values, and Checksum values. If the NOC 24 determines that the decompression was ineffective, method 100 preferably returns to 112. A condition that might lead to ineffective decompression is a situation where the history or dictionary data 38 on the remotely located device 14 and the history or dictionary data 42 at the NOC 24 is not the same. At 112, a retransmission of the requested information is generated and communicated where the request preferably indicates that the remote device 14 is to compress the requested information using a standard compression engine without seeding.

If at 120 the decompression of the remote device's 14 information is determined to have been effective, method 100 preferably proceeds to 124. At 124, the remote device's 14 decompressed information is preferably stored by the NOC 24 for use by one or more diagnostic evaluation or reporting programs. Upon storage of the decompressed information at 124, method 100 preferably proceeds to 130.

At 130, the NOC preferably stores the current information as the reporting remote device's 14 history or dictionary data 42. In one embodiment of the present invention, the previous history dictionary data 42 for the reporting remote device 14 may be replaced with the current remote device 14 operating information. In an alternate embodiment, a rolling remote device 14 history or dictionary data 42 may be maintained by the NOC 24. Once the current remote device 14 information has been stored, method 100 preferably ends at 128 and the NOC 24 may await the next remote device 14 reporting event.

In an alternative embodiment, before the NOC 24 stores the decompressed information in data dictionary, the NOC 24 may evaluate the decompressed information to determine its actual contents. For example, the NOC 24 may have requested that the remote device 14 report its current, complete operating status. On the other hand, the NOC 24 may have requested that the reporting remote device 14 communicate the status of one or more hardware 16 parameters. If the decompressed information is determined to contain only portions of the remote device's 14 operating or other status (e.g., characteristics of the remote device 14 not maintained in a history or dictionary data 42), the NOC 24 may not update data dictionary 42. However, if the decompressed information is determined to contain the remote device's current information (e.g., characteristics of the remote device 14 maintained in a history or data dictionary 42), the NOC 24 may update the history or data dictionary 42 with the decompressed information.

Although the present invention has been described with respect to one or more specific example embodiments, various changes and modifications to those embodiments may be suggested to one skilled in the art. As described above, many different types of compression engines may be used in alternative embodiments. Also, many different types of compression algorithms may be used, including without limitation Huffman coding algorithms, Shannon-Fano coding algorithms, arithmetic coding algorithms, and Ziv-Lempel algorithms (also known as Lempel-Ziv algorithms). The present invention is not to be limited to the specific embodiments described above, but is to encompass such changes and modifications as fall within the scope of the appended claims.

What is claimed is:

1. A method of communicating between a first device and a second device comprising:
compiling device status information for the first device;
accessing a memory included on the first device to determine whether a prior device status information exists therein;
providing the prior device status information located in the memory to a compression engine available to the first device if the prior device status information is located in the memory;
compressing the device status information using the prior device status information and the compression engine if the prior device status information is located in the memory;
initiating compression without using prior device status information if no prior device status information is located in the memory; and
communicating the compressed device status information from the first device to the second device.

2. The method of claim 1 further comprising:
receiving, by the second device, the compressed device status information;
identifying the compression engine used by the first device to compress the device status information; and
decompressing the compressed device status information according to the identified compression engine.

3. The method of claim 2 further comprising:
evaluating the integrity of the decompressed device status information to identify any failures in decompression or transmission; and
requesting retransmission of the device status information in response to the identification of a decompression or transmission failure.

4. The method of claim 1 further comprising requesting, by the second device, transmission of the device status information from the first device.

5. The method of claim 1 further comprising:
determining whether prior device status information is available to the second device;
if prior device status information is unavailable, requesting compression of the requested device status information using the compression engine without providing prior device status information to the compression engine; and
if prior device status information is available, requesting compression of the requested device status information using a compression engine capable of using the prior device status information for compression.

6. The method of claim 1, wherein the operation of compressing the device status information using the prior device status information and the compression engine comprises compressing the device status information using dictionary data derived from the prior device status information.

7. The method of claim 1 further comprising storing the device status information in the memory of the first device as an updated prior device status information.

8. The method of claim 1 further comprising communicating between the first device and the second device via a wireless communications link.

9. The method of claim 1, wherein:
the operation of compiling device status information for the first device comprises compiling device status information for a remote point of sale device; and
the operation of communicating the compressed device status information from the first device to the second device comprises communicating the compressed device status information from the remote point of sale device to the second device.

10. The method of claim 1, wherein the operation of compressing the device status information using the prior device status information and the compression engine comprises:
using a ZLIB compression engine to compress the device status information using dictionary data derived from the prior device status information.

11. The method of claim 1, wherein the operation of initiating compression without using prior device status information comprises:
initiating compression with a compression algorithm selected from the group consisting of:
a Ziv-Lempel compression algorithm;
a Huffman coding algorithm;
a Shannon-Fano coding algorithm; and
an arithmetic coding algorithm.

12. The method of claim 1, wherein the operation of compiling device status information for the first device comprises:
compiling direct exchange/uniform communication standard (DEX/UCS) data for the first device.

13. The method of claim 1, wherein:
the operation of providing the prior device status information to the compression engine comprises providing information derived from a previous communication of remote device status information to the compression engine; and
the operation of compressing the device status information using the prior device status information and the compression engine comprises compressing the device status information using the information derived from the previous communication of remote device status information as dictionary data.

14. A remote device management system comprising:
at least one remote device;
the remote device including:
a memory,
a processor operably coupled to the memory,
a communications interface operably coupled to the processor, and
a first program of instructions storable in the memory and executable by the processor;
a network operations center communicatively coupled to the at least one remote device;
the network operations center including:
a memory,
a processor operably coupled to the memory,
a communications interface operably coupled to the processor, and
a second program of instructions storable in the memory and executable by the processor;
the first program of instructions operable to:
determine whether prior device status information is present in the memory of the remote device,
if prior device status information is present, communicate the prior device status information to a compression engine capable of using dictionary data during compression, such that current device status information may be compressed using the compression engine capable of using dictionary data during compression,
if prior device status information is not present, initiate compression of the current device status information without using prior device status information,
transmit the compressed current device status information to the network operations center via the communications interface,
verify accurate transmission of the compressed current device status information, and
store the current device status information in the memory as an updated prior device status information;
the network operations center operable to receive compressed information containing the compressed current device status information transmitted by the remote device; and
the second program of instructions operable to:
determine the compression engine used to compress the received compressed information,
decompress the received compressed information into decompressed information according to the compression engine used,
verify that the compressed information was effectively decompressed,
if the decompression was ineffective, request retransmission of the current device status information,
determine whether the decompressed information contains current device status information, and
if the decompressed information contains current device status information, store the decompressed information as an updated prior device status information.

15. The remote device management system of claim 14 further comprising the remote device operable to report current device status information according to a predetermined reporting schedule.

16. The remote device management system of claim 14 wherein the request for retransmission includes a request for retransmission of data compressed without using prior device status information.

17. The remote device management system of claim 14 further comprising the network operations center operable to request current device status information from the remote device.

18. The remote device management system of claim 14 further comprising the first program of instructions operable to collect the current device status information.

19. The remote device management system of claim 14 further comprising the current device status information including direct exchange/uniform communication standard (DEX/UCS) data.

20. The remote device management system of claim 14 further comprising the current device status information including Multi-Drop Bus (MDB) data.

21. The remote device management system of claim 14 further comprising the remote device including dispensing equipment.

22. The remote device management system of claim 14 wherein the current device status information is stored in the memory of the remote device as a device history.

23. The remote device management system of claim 14 wherein the compression engine capable of using dictionary data during compression comprises a ZLIB compression engine.

24. The remote device management system of claim 14 wherein the remote device compresses the current device status information using a compression algorithm selected from the group consisting of:
a Ziv-Lempel compression algorithm;
a Huffman coding algorithm;
a Shannon-Fano coding algorithm; and
an arithmetic coding algorithm.

25. A method for communicating information between a first source and a second source comprising:
accessing information to be communicated from a memory of the first source;
determining whether previously communicated information is available to the first source;
if previously communicated information is available, providing the previously communicated information to a compression engine;
generating, by the compression engine, a symbol predicting probability distribution;
building, by the compression engine, a dictionary of encoded symbols;
providing to the compression engine the information to be communicated;
compressing, by the compression engine, the information to be communicated according to the dictionary of encoded symbols;
if previously communicated information is unavailable, initiating compression without providing previously communicated information to the compression engine; and
transmitting the compressed information to be communicated from the first source to the second source.

26. The method of claim 25 further comprising:
determining, by the second source, a method used to compress the transmitted, compressed information;
if the transmitted, compressed information was compressed using a compression engine capable of using a dictionary of encoded symbols obtained from prior information for compression, determining whether previously communicated information is available to the second source;
if previously communicated information is available, decompressing the transmitted, compressed information using a decompression engine capable of using a dictionary of encoded symbols obtained from prior information for decompression;
if previously communicated information is unavailable, requesting retransmission of the information to be communicated compressed without using previously communicated information; and
if the transmitted, compressed information is determined to have been compressed without using previously communicated information, initiating decompression of the transmitted, compressed information without using previously communicated information.

27. The method of claim 25 further comprising requesting, by the second source, retransmission of the information to be communicated in response to a determination by the second source of faulty information receipt.

28. The method of claim 25 further comprising requesting, by the second source, the information to be communicated.

29. The method of claim 25 further comprising transmitting, by the first source, the information to be communicated according to a predetermined schedule.

30. The method of claim 25 wherein the operation of accessing information to be communicated from the first source comprises:
accessing information to be communicated from remote point of sale equipment.

31. The method of claim 25 wherein the operation of accessing information to be communicated from the first source comprises:
accessing direct exchange/uniform communication standard (DEX/UCS) data to be communicated from the first source.

32. The method of claim 25 wherein the operation of accessing information to be communicated from the first source comprises:
accessing Multi-Drip Bus (MDB) data to be communicated from the first source.

33. The method of claim 25 wherein the operation of compressing, by the compression engine, the information to be communicated comprises:
using a ZLIB compression engine to compress the information to be communicated.

34. The method of claim 25 wherein the operation of initiating compression without providing previously communicated information to the compression engine comprises:
initiating compression with a compression algorithm selected from the group consisting of:
a Ziv-Lempel compression algorithm;
a Huffman coding algorithm;
a Shannon-Fano coding algorithm; and
an arithmetic coding algorithm.

35. A remote device management system, comprising:
at least one remote device that includes a memory, a processor operably coupled to the memory, and a communications interface operably coupled to the processor;
a first set of instructions storable in the memory of the remote device and executable by the processor of the remote device;
a network operations center (NOC) communicatively coupled to the remote device, the NOC including a memory, a processor operably coupled to the memory, and a communications interface operably coupled to the processor; and
a second set of instructions storable in the memory of the NOC and executable by the processor of the NOC;
the first set of instructions operable to:
utilize dictionary data to compress current device status information for the remote device; and
transmit the compressed current device status information to the NOC via the communications interfaces of the remote device and the NOC;
the second set of instructions operable to:
receive compressed information containing the compressed current device status information transmitted by the remote device; and
decompress the received compressed information into decompressed device status information for the remote device.

36. The remote device management system of claim 35, wherein:
the dictionary data comprises device-specific dictionary data derived from prior device status information for the remote device; and
the first set of instructions uses the device-specific dictionary data to compress the current device status information for the remote device.

37. A dispensing machine with processing resources for communicating status information to a remote-network operations center, the dispensing machine comprising:
a chassis containing dispensing equipment;
a computing device in the chassis that includes a memory and a processor operably coupled to the memory, the processor operable to process status information pertaining to the dispensing equipment;
a communications interface operably coupled to the processor, the communications interface operable to support communications between the computing device and a remote network operations center (NOC);
a first set of instructions storable in the memory of the computing device and executable by the processor of the computing device, the first set of instructions operable to:
utilize dictionary data to compress current device status information for the dispensing machine into compressed data; and
transmit the compressed data to the NOC via the communications interface, such that a computer system in the NOC may decompress the compressed data into the current device status information for the dispensing machine.
